(19) United States
(12) Patent Application Publication
(10) Pub. No.: US 2026/0226922 A1
(43) Pub. Date: Aug. 6, 2026

(54) HYDRAULIC ACTUATOR

(71) Applicant: SVM Schultz Verwaltungs-GmbH & Co. KG, Memmingen (DE)

(72) Inventor: Paul Philipp Herz, Argenbühl (DE)

(21) Appl. No.: 19/465,981

(22) Filed: Jan. 30, 2026

(30) Foreign Application Priority Data
Feb. 6, 2025 (DE) 10 2025 104 481.3

(51) Int. Cl. F15B 13/04; F15B 13/01; F15B 13/044

(52) U.S. Cl. CPC F15B 13/0403; F15B 13/01; F15B 13/044

(57) ABSTRACT

A hydraulic actuator traversed by a longitudinal axis includes a housing with an inlet and an outlet, a first fluid path and a second fluid path extending from the inlet to the outlet, a main valve spool adjustable between open and closed positions, a pilot valve spool adjustable between an open and closed position, and an actuator piston movable between retracted and extended positions. A method of operating the hydraulic actuator is also disclosed.

### CROSS-REFERENCE TO RELATED APPLICATIONS

This non-provisional application claims the benefit of, and priority to, German Application No. 10 2025 104 481.3, filed on Feb. 6, 2025, which is incorporated by reference in its entirety.

### FIELD OF THE DISCLOSURE

The present disclosure generally relates to a hydraulic actuator.

### BACKGROUND

Hydraulic actuators can be pilot-controlled. However, their actuator pistons can often only be retracted slowly. In the hydraulic actuators, leakage at many leakage points must be minimized through complex design measures. Furthermore, the hydraulic actuators require a lot of installation space.

### SUMMARY

A hydraulic actuator, having a longitudinal axis, including a housing with an inlet and an outlet, a first fluid path from the inlet to the outlet, a second fluid path from the inlet to the outlet, a main valve spool, a pilot valve spool, and an actuator piston. The main valve is adjustable along the longitudinal axis to a single open position or to a double open position. The pilot valve spool is arranged coaxially with the main valve spool and adjustable along the longitudinal axis between an open position, in which the second fluid path is open, and a closed position, in which the second fluid path is closed. The actuator piston is arranged coaxially with the main valve spool and adjustable along the longitudinal axis by fluid pressure from the inlet between a retracted position and an extended position.

The method of operation for a hydraulic actuator, including the following steps from a basic state of the hydraulic actuator in which a first fluid path and a second fluid path are open, an actuator piston is in its retracted position and a main valve spool is moved to its pre-closed position, in which a volume flow of a first fluid path is greater than the volume flow of a second fluid path, moving the pilot valve spool from its open position to its closed position, thereby closing the second fluid path, moving the main valve spool to its closed position by means of the fluid pressure present at the inlet, thereby closing the first fluid path and the second fluid path, moving the actuator piston to its extended position by means of fluid pressure present at the inlet, moving the pilot valve spool from its closed position to its open position, thereby opening the second fluid path, interrupting the fluid pressure on the main valve spool and moving the main valve spool from its closed position to the single open position or to the double open position, allowing a flow of fluid through the hydraulic actuator from the inlet to the outlet along at least one of the two fluid paths, interrupting or reducing the volume flow at the inlet and moving the pilot valve spool from its open position to its closed position, thereby closing the second fluid path, moving the actuator piston to its retracted position and thereby moving the main valve spool to its pre-closed position.

### BRIEF DESCRIPTION OF THE DRAWINGS

For a more complete understanding of this disclosure, reference is now made to the following description, taken in conjunction with the accompanying drawings, in which:

FIG. 1 illustrates a cross-sectional view of a hydraulic actuator in a first state,

FIG. 2 illustrates a cross-sectional view of the hydraulic actuator in a second state;

FIG. 3 illustrates a cross-sectional view of the hydraulic actuator in a third state;

FIG. 4 illustrates a cross-sectional view of the hydraulic actuator in a fourth state;

FIG. 5 illustrates a cross-sectional view of the hydraulic actuator in a fifth state

FIG. 6 illustrates a cross-sectional view of the hydraulic actuator in a sixth state;

FIG. 7 illustrates a cross-sectional view of the hydraulic actuator in a seventh state;

FIG. 8 illustrates a cross-sectional view of the hydraulic actuator in an eighth state; and

FIG. 9 illustrates a cross-sectional view of the hydraulic actuator in a ninth state.

### DETAILED DESCRIPTION

In the figures, like or corresponding elements are designated by the same reference signs and are therefore not described again unless necessary. Features already described are not described again to avoid repetition and are applicable to all elements with like or corresponding reference signs, unless explicitly excluded. The disclosures contained in the entire description are transferable by analogy to identical parts with like reference signs or like component designations. The positional information chosen in the description, such as above, below, sideways, etc., also refers to the figure directly described and depicted and is to be transferred by analogy to the new position in the event of a change in position. Furthermore, individual features or combinations of features from the various embodiments shown and described can also represent independent, inventive or innovative solutions.

Disclosed is a hydraulic actuator, which is traversed by a longitudinal axis. The hydraulic actuator has a housing with an inlet and an outlet, a first fluid path from the inlet to the outlet, a second fluid path from the inlet to the outlet, and a main valve spool adjustable along the longitudinal axis to a single open position in which the first fluid path or the second fluid path is open and the other of the first or second fluid path is closed and/or to a double open position in which the first fluid path and the second fluid path are open, and a closed position in which the first fluid path and the second fluid path are closed. The hydraulic actuator also has a pilot valve spool arranged coaxially with the main valve spool, which is adjustable along the longitudinal axis between an open position in which the second fluid path is open, and a closed position in which the second fluid path is closed. The hydraulic actuator also has an actuator piston arranged coaxially with the main valve spool and that is adjustable along the longitudinal axis by fluid pressure from the inlet between a retracted position and an extended position.

The hydraulic actuator can be a parking lock or part of a parking lock.

The hydraulic actuator, which is pilot-controlled by a pilot valve spool, is very small, especially in diameter, due to the coaxial design of the main valve spool, pilot valve spool, and actuator piston. The coaxiality refers to the arrangement and/or adjustability. Through the interaction of the two valve spools and two fluid paths, the hydraulic actuator can assume several states and be highly functional.

A change of state can occur as follows. When the pilot valve spool is moved to its closed position, the second fluid path is closed (and the connection between the inlet and outlet via the second fluid path is disconnected), so that the entire volume flow flows through the first fluid path. This creates a higher pressure difference across the main valve spool, allowing the main valve spool to move to its double closed position. Flow forces amplify this effect. In its double closed position, the main valve spool closes both the first and second fluid paths. There is now no connection between the inlet and outlet. By closing both fluid paths, pressure builds up by the fluid at the inlet to move the actuator piston from its retracted position to its extended position.

In its basic state, fluid flows through the hydraulic actuator from the inlet to the outlet. The volume flow is divided between the two fluid paths. The volume flow can be controlled by the main valve spool and pilot valve spool. The inlet and outlet are fluidly coupled via the fluid paths, in aspects, exclusively via the two fluid paths. This reduces the space required for installation. As long as one of the valve spools is in the closed position, the fluid connection between the inlet and outlet along the corresponding fluid path is interrupted. The corresponding fluid path is completely closed and the volume flow in the corresponding fluid path is zero or approximately zero due to leakage.

If the main valve spool is in its open position, the respective fluid path at the main valve spool is open. When the main valve spool is in its closed position, the respective fluid path at the main valve spool is closed—the volume flow in the corresponding fluid path is zero or, due to leakage, approximately zero. The main valve spool can (only) be moved into (up to the closed position) and out of the first fluid path. The main valve spool can be moved into (up to the closed position) and out of the first fluid path and the second fluid path. If a fluid path is closed by one of the two valve spools and opened by the other, the entire fluid path can be described as partially open. In aspects, the main valve spool is designed and/or arranged in such a way that it can be pressed into its closed position and/or secured there by the fluid pressure at the inlet or in the first valve chamber. In aspects, the main valve spool has a closing position pressure surface. The closing position pressure surface is exposed to the fluid pressure present at the inlet or in the first valve chamber. This enables rapid adjustment, In aspects, from the pre-closed position to the closing position. In aspects, the closing position pressure surface limits the first valve chamber in the closed position of the main valve spool. This allows the closed position to be secured. Pressure applied to the closing position pressure surface can secure the main valve spool in its closed position when it is in the closed position.

If the pilot valve spool is in its open position, the respective fluid path at the pilot valve spool open. If the pilot valve spool is in its closed position, the respective fluid path at the pilot valve spool is closed and the volume flow in the corresponding fluid path is zero or approximately zero due to leakage. The pilot valve spool can (only) be moved into the second fluid path (up to the closed position) and out of it.

The first fluid path is different from the second fluid path. In aspects, the first fluid path extends from the inlet into a first valve chamber and/or into a third valve chamber and then to the outlet. In aspects, the second fluid path extends from the inlet into a/the first valve chamber and/or into a second valve chamber and/or into a/the third valve chamber and then to the outlet. The use of shared chambers reduces the space required for installation. In aspects, the inlet connects to the first valve chamber directly to reduce the space required for installation. In aspects, the outlet connects to the third valve chamber directly to reduce the space required for installation. In aspects, the first valve chamber is fluidly connected to the second valve chamber via the first fluid opening. In aspects, the second valve chamber is fluidically connected to the third valve chamber via the second fluid opening. In aspects, the first valve chamber is fluidically connected to the third valve chamber via the control edge. All these designs result in a compact construction.

The housing can be the outer housing of the hydraulic actuator. The housing can contain an electromagnet. The electromagnet can be a linear magnet. The electromagnet and/or the armature and/or the armature rod can be coaxial with the main valve spool. The armature and/or the armature rod can be adjustable along the longitudinal axis. This reduces the space required for installation. The armature rod can be attached to the armature and thus be adjustable. The electromagnet can be arranged at the front end of the housing or form a front end of the housing. The hydraulic actuator can comprise the electromagnet.

The pilot valve spool can be biased into one of its positions by means of a pilot valve spool spring. The pilot valve spool can be connected to or removed from the armature and/or the armature rod. It is thus adjustable into one of its positions. The pilot valve spool and the main valve spool spring can be separate parts. The pilot valve spool spring can bias the armature and/or the armature rod to a de-energized position. In aspects, the armature and/or the armature rod are extended when the electromagnet is de-energized. When energized, the armature and/or the armature rod can be moved into the coil of the electromagnet. Since the pilot valve spool spring can take over the function of the armature spring, a dedicated armature spring is not required, thus reducing the number of components. The pilot valve spool and the main valve spool are separate parts and/or can be adjusted independently of each other.

The main valve spool can be biased into one of its positions, In aspects, into its single open position, by means of a main valve spool spring. The pilot valve spool can be connected to the armature and/or the armature rod in order to be adjustable into one of its positions, in aspects, into its closed position.

The actuator piston can be biased into one of its positions by means of an actuator piston spring, in aspects, into its retracted position. The actuator piston can have a pressure surface which is exposed to the fluid present at the inlet, in aspects, delimiting the first valve chamber. This serves to enable it to be adjusted quickly. In its retracted position, the actuator piston is retracted into the housing. In its extended position, the actuator piston is extended out of the housing.

In aspects, the actuator piston rests against the main valve spool in its retracted position and can thereby move it into a pre-closed position within its single open position and/or double open position wherein the volume flow of the first fluid path is greater than the volume flow of the second fluid path.

The actuator piston defines a (first) main valve spool stop due to its contact with the main valve spool. The actuator piston can therefore be coupled with the main valve spool in one of its two open positions in its retracted position. The contact can be a floating connection. The actuator piston and/or the main valve spool can each have contact surfaces that face each other, In aspects, running perpendicular to the longitudinal axis. This prevents transverse forces.

The contact position can be spring-biased, in aspects by the main valve spool spring or the actuator piston spring, or even better by the main valve spool spring and actuator piston spring, which act towards each other in opposite directions. In aspects, the actuator piston spring is stronger than the main valve spool spring. In aspects, a balance of forces between the actuator piston spring and the main valve spool spring defines the contact position and/or pre-closed position.

In aspects, the actuator piston does not rest against the main valve spool in its extended position or is axially spaced from it. This increases the travel of the actuator piston and enables the main valve spool to perform additional functions.

The pre-closed position serves to reduce positioning times. The pre-closed position can be a position of the main valve spool from which it can be pressed into its closed position due to fluid pressure at the inlet or in the first fluid path or a pressure difference across the main valve spool. The pressure difference can result from the fact that the volume flow of the first fluid path is greater than the volume flow of the second fluid path.

The pre-closed position or the (first) main valve spool stop can be an element of a flip-flop valve. The flip-flop valve can be used to control the actuator piston. Due to the contact between the actuator piston and the main valve spool, there is a coupling between the actuator piston and the main valve spool. The flip-flop valve can only be activated when the actuator piston is in the retracted position. In aspects, the pre-closed position and/or the contact allows the flip-flop valve to be activated.

In aspects, it can be provided that the hydraulic actuator comprises a locking mechanism comprising a driving element. In aspects, this driving element is a tapered element or cone arranged on the pilot valve spool, The hydraulic actuator further comprises at least one latching receptacle, in aspects, the at least one latching receptacle, or alternatively both latching receptacles, is/are arranged on the actuator piston, and at least one latching element (e.g., a ball), wherein the latching element can be driven by the driving element into the latching receptacle in order to lock the actuator piston in the axial direction.

The hydraulic actuator can have at least one latching element, and the actuator piston can have a first latching receptacle and a second latching receptacle. Each latching receptacle can be assigned a latching element. The actuator piston can be fixed by the retaining interaction of the at least one latching element with one of the corresponding latching receptacles. This allows the actuator piston to be easily locked in the axial direction. In the driving position, the at least one latching element can be arranged simultaneously in a fixed locking opening and the corresponding latching receptacle, which is basically movable in the longitudinal direction. Since the driving element prevents the latching element from escaping from the latching receptacle, the actuator piston is locked in the axial direction.

In aspects, each latching receptacle has a push-out bevel. This can serve on the one hand to bring the corresponding latching element from the latching receptacle during longitudinal adjustment of the latching receptacle while the driving element is in the non-driving position.

In aspects, the latching element(s) can be pushed into either the first latching receptacle or the second latching receptacle. This allows the number of latching elements to be kept small. In aspects, pushing the latching element(s) into the first latching receptacle(s) locks the actuator piston in its retracted position. In aspects, pushing the latching element(s) into the second latching receptacle(s) locks the actuator piston in its extended position.

The driving element can be arranged along the longitudinal axis and/or coaxially with the main valve spool and can be adjustable between a driving position, in which the latching element(s) is/are pushed into the respective latching receptacle, and a non-driving position, in which the latching element(s) can be released from the respective latching receptacle. In the driving position, the actuator piston can be locked in the axial direction. In the non-driving position, the actuator piston can be unlocked in the axial direction or can move longitudinally.

The driving element can be firmly connected to and/or formed integrally with the armature and/or the armature rod of the electromagnet and/or the pilot valve spool. Alternatively, it can be a separate part. The driving element can then be adjusted between the driving position and the non-driving position by adjusting the armature and/or armature rod and/or pilot valve spool. The time-sensitive locking of the actuator piston can now be carried out quickly and reliably. The connection between the driving element and the pilot valve spool means that both are relatively stationary in relation to each other. An advantageous coupling between the pilot valve function and the locking function is created. Separate locking and unlocking is therefore not necessary.

In aspects, the pilot valve spool and the driving element are designed and/or arranged in such a way that the open position of the pilot valve spool and the driving position of the driving element are simultaneous.

In aspects, the pilot valve spool and the driving element are designed and/or arranged in such a way that the closed position of the pilot valve spool and the non-driving position of the driving element are simultaneously given.

The driving element serves to press the at least one latching element radially outwards into a latching receptacle of the piston (driving position) or not to press it radially outwards (non-driving position), depending on its position. When the driving element is in the appropriate position, this achieves a locking of the actuator piston.

In aspects, it can be provided that the hydraulic actuator comprises one/the electromagnet, which can adjust the pilot valve spool along the longitudinal axis; in aspects, the pilot valve spool is connected to the armature or the armature rod in a fixed manner. The connection can be a form-fitting, frictionally engaged or integrally bonded connection, or a combination thereof. In aspects, the pilot valve spool with armature or armature rod is a one-piece design.

Since both the pilot valve spool and the driving element can be connected to the armature and/or the armature rod, both can be adjusted with the electromagnet. In aspects, the pilot valve spool is in its open position when the solenoid coil of the electromagnet is de-energized. This allows a fluidic connection between the inlet and outlet to be free in the event of a power failure. This is particularly advantageous in fluid systems in which the hydraulic actuator is arranged in the regular flow.

In aspects, a (first) compensation channel is formed between the armature and the armature rod. In aspects, a (second) compensation channel is formed between the armature rod and the pilot valve spool and/or driving element. The channel can extend in the axial direction. Fluid can flow through the respective compensation channel during adjustment, thereby reducing resistance and increasing the adjustment speed.

In aspects, it can be provided that the hydraulic actuator comprises a control edge which can adjust the volume flow of the first fluid path with the main valve spool. The control edge can also serve to close the first fluid path. In aspects, the main valve spool is pressurized in its pre-closed position in the direction of the control edge by contact with the actuator piston. The control edge can be formed by the housing and/or an insert inserted into the housing. This serves to achieve a compact design.

In aspects, it can be provided that the hydraulic actuator comprises an inner wall, In aspects, an inner sleeve, within the housing, wherein the inner wall can guide the main valve spool. The inner wall can have a guide surface for the main valve spool on the inner or outer circumferential side. The guide there reduces the number of components and the space required for installation. The inner sleeve can be a hollow cylinder.

The inner wall can have a (second) main valve spool stop. In aspects, the main valve spool rests against the (second) main valve spool stop in its single open position. For space reduction, in aspects, two different stops are formed for the main valve spool in an axial direction. The first of these stops can be the (first) main valve spool stop on the actuator piston. The second of these stops can be the (second) main valve spool stop on the inner wall or the housing. In aspects, the main valve spool rests against the stops depending on the position of the actuator piston. If the actuator piston is in its retracted position, in aspects, the main valve spool can only rest against the (first) main valve spool stop on the actuator piston. If the actuator piston is in its extended position, in aspects, the main valve spool can only rest against the (second) main valve spool stop on the inner wall or the housing.

In aspects, the hydraulic actuator can be moved to a fully open position in which the flow of fluid from the inlet to the outlet is maximum and the flow resistance is minimum. In aspects, the main valve spool in its single or double open position realizes the fully open position. In aspects, in the fully open position, the pilot valve spool valve is in its open position. This reduces the flow resistance.

In aspects, the main valve spool in its single closed position and/or in the fully open position, closes the first fluid opening and thereby closes the second fluid path. The entire volume flow can/must then flow through the first fluid path. This has the advantage that less dirt enters via the pilot valve spool. In addition, installation space can be saved.

The inner wall can form a support surface for one/the main valve spool spring. The surface there reduces the number of components and the space required for installation.

The inner wall can guide the pilot valve spool. The inner wall can have a guide surface for the pilot valve spool on the inner or outer circumferential side. The guide there reduces the number of components and the space required for installation. In aspects, it is advantageous for the pilot valve spool to be guided on the inner circumferential side and the main valve spool on the outer circumferential side (or vice versa) of the inner wall. The travel distances of the pilot valve spool and the main valve spool can overlap in the radial direction. This enables a compact design.

The inner wall can form a support surface for one/the pilot valve spool spring. The surface there reduces the number of components and the space required for installation.

The inner wall can guide the actuator piston. The inner wall can have a guide surface for the actuator piston on the inner or outer circumferential side. The guide there reduces the number of components and the space required for installation. In aspects, it is advantageous for the actuator piston and the main valve spool to be guided on the same side (inner or outer circumferential side) of the inner wall at the outer circumferential side. This allows the actuator piston to be mounted compactly on the main valve spool.

The inner wall can have a retraction stop for the actuator piston. The retraction stop can be a front end of the inner wall, thereby achieving a compact design. In aspects, the actuator piston rests against the retraction stop in its retracted position. In aspects, the contact of the actuator piston with the retraction stop defines the contact position and/or pre-closed position.

The inner wall can have a first fluid opening which leads to the second fluid path and can be closed and opened by the main valve spool and/or pilot valve spool. The first fluid opening can lead the second fluid path from an outer circumferential side of the inner wall to an inner circumferential side of the inner wall. Advantageously, the first fluid opening can be closed by both valve spools, which is equivalent to separating the fluid connection between the inlet and outlet via the second fluid path. This design serves to create a compact yet highly functional hydraulic actuator. The first fluid opening can be closed in the closed position of the pilot valve spool. The first fluid opening can be closed in the single open position of the main valve spool. The first fluid opening can be open when the pilot valve spool is in its open position, and the main valve spool is in its double open position or its closed position.

The inner wall can have a second fluid opening which leads to the second fluid path and can be closed and opened only by the main valve spool.

The second fluid opening can guide the second fluid path from an inner circumferential side of the inner wall to an outer circumferential side of the inner wall. This enables a compact design. Advantageously, the second fluid opening can only be closed by the main valve spool, which is equivalent to separating the fluid connection between the inlet and outlet via the second fluid path. This design results in a compact yet highly functional hydraulic actuator. The second fluid opening can be closed when the main valve spool is in the closed position. The second fluid opening can be open when the main valve spool is in its single open position and when it is in its double open position.

However, if the first fluid opening is open and the main valve spool is in its closed position, the second fluid path remains closed by the main valve spool, so that the fluid pressure at the actuator piston cannot be reduced. The actuator piston can be locked in this state. The locking is thus decoupled from the hydraulic control. The complete separation of the fluid connection between the inlet and outlet is maintained, even though the pilot valve spool opens the first fluid opening. This circuit can be referred to as a flip-flop circuit of the flip-flop valve.

The inner wall can have a locking opening in which the locking mechanism is accommodated. The locking opening can be oriented in the radial direction. The locking opening can serve to accommodate a latching element. A latching element can be assigned to each latching opening. Depending on its position in the radial direction, the driving element can push the latching elements outwards through the respective latching opening into the corresponding latching receptacle. This also enables a compact design.

The inner wall and/or the main valve spool can form a separation between the first fluid path and the second fluid path. This enables a compact design.

The inner wall can guide the second fluid path at the inner circumferential side, In aspects, from the first fluid opening to the second fluid opening. This enables a compact design.

The inner wall can be free of undercuts in the longitudinal direction, apart from any fluid openings. This enables cost-effective production, especially in the case of a single-piece design with the housing.

The inner wall can be open at one end to the actuator piston. This enables a fluid connection from the outer circumferential side of the inner wall via a (third) compensation channel to the inner circumferential side of the inner wall. The compensation channel increases the adjustment speed.

The first fluid opening can be arranged upstream of the second fluid path to the second fluid opening. This enables a compact design.

The armature rod can extend within the inner wall and/or be arranged in the second fluid path. The pilot valve spring can extend within the inner wall and/or be arranged in the second fluid path. Both enable a compact design.

In aspects, it can be provided that the housing guides the main valve spool.

The housing can have a guide surface for the main valve spool on the inner circumferential side. The guide there reduces the number of components and the space required for installation. In aspects, the housing is designed in such a way that the guide through the housing only takes place in the closed position of the main valve spool. This allows a direct guide for the second fluid path through the housing to be realized. In aspects, the housing is designed in such a way that the guide through the housing closes the second fluid path. The main valve spool can, for example, slide past the control edge, whereby the second fluid path can be closed at the control edge. Alternatively, an insert can guide the main valve spool.

The housing can guide the pilot valve spool. The housing can have a guide surface for the pilot valve spool on the inner circumferential side. The guide there reduces the number of components and the space required for installation.

The housing can guide the actuator piston. The housing can have a guide surface for the actuator piston on the inner circumferential side. The guide there reduces the number of components and the space required for installation.

The housing can have at least one main valve spool stop for the main valve spool. In aspects, the housing forms one/the (second) main valve spool stop and/or one/the (third) main valve spool stop. In aspects, the main valve spool rests against the (second) main valve spool stop in its single open position. In aspects, the main valve spool rests against the (third) main valve spool stop in its closed position. The second main valve spool stop, and the third main valve spool stop can be arranged facing each other and/or define the ends of the travel range of the main valve spool. In aspects, the first main valve spool stop is formed between the second and third main valve spool stops along the longitudinal axis. This serves to achieve a compact design and can be used to implement the flip-flop valve.

The housing can form a support surface for one/the main valve spool spring. The surface there reduces the number of components and the space required for installation.

The housing can form a support surface for one/the pilot valve spool spring. The surface there reduces the number of components and the installation space required.

The housing can form a support surface for one or more actuator piston springs. The surface there reduces the number of components and the installation space required.

The housing can have the inlet and outlet adjacent to each other along the longitudinal axis or aligned in the axial direction. The inlet and outlet are thus on the same side, which allows for short fluid paths and low space requirements.

The housing can have or form a first valve chamber and/or a second valve chamber and/or a third valve chamber. In aspects, the first valve chamber is connected fluidically to the second valve chamber and the third valve chamber directly. In aspects, the second valve chamber is connected fluidically to the third valve chamber directly. The direct connection in particular leads to a compact design. In aspects, the control edge separates the first valve chamber from the third valve chamber.

In aspects, the first valve chamber is delimited at the outer circumferential side by the housing and/or at the inner circumferential side by the inner wall and/or the main valve spool and/or one/the pressure surface of the actuator piston. This allows fluid to act directly on the pressure surface of the actuator piston after entering through the inlet. Deep penetration of the fluid pressure is thus avoided.

In aspects, the second valve chamber is formed within the inner wall. The second valve chamber can be delimited at the outer circumferential side by the inner wall. The second valve chamber can be delimited axially at one end by a support surface of the pilot valve spring and/or axially at the other end by the pilot valve spool. This serves to reduce the space required for installation.

In aspects, the third valve chamber is delimited at the outer circumferential side by the housing and/or on the inner circumferential side by the inner wall and/or the main valve spool.

In aspects, the inner wall or inner sleeve is formed in one piece with the housing. This reduces the number of components.

The housing can have a retraction stop for the actuator piston. In aspects, the actuator piston rests against the retraction stop in its retracted position. In aspects, the contact of the actuator piston with the retraction stop defines the contact position and/or pre-closed position. In aspects, only one of the inner wall and the housing has a retraction stop.

In aspects, it can be provided that the actuator piston has a sleeve portion. The sleeve portion can be formed axially at one end and/or guided on the inner wall or the housing. In aspects, the sleeve portion is guided at the outer circumferential side of the inner wall.

The actuator piston or sleeve portion can have at least one flow-through opening which can guide the second fluid path. This design serves to allow a fluid flow along the second fluid path in the closed position at the main valve spool.

The actuator piston can have a disc portion. The disc portion can be sealed in the longitudinal direction and can seal a hydraulic actuator interior against a hydraulic actuator environment. The sleeve portion can be attached to the disc portion, resulting in a compact design. The disc portion can form a/the pressure surface of the actuator piston. The disc portion can be guided on the inner circumferential side of the housing.

The actuator piston or sleeve portion can have at least one latching receptacle on the inner circumferential side. This also serves to achieve a compact design, especially in terms of diameter.

In aspects, the main valve spool has a flow-through opening which guides the second fluid path. This design serves to allow a fluid flow along the second fluid path in the contact position at the main valve spool.

The main valve spool can have a stop flange. This allows the closed position and/or single open position of the main valve spool to be defined and ensured. The stop flange can extend in the radial direction. The stop flange can rest against the second main valve spool stop and/or the third main valve spool stop. This allows the stop flange to serve as a double stop. In aspects, the stop flange has a pressure surface that is exposed to the fluid flowing into the inlet. This serves to quickly move it from the pre-closed position to its closed position.

The main valve spool or the stop flange can have a (fourth) compensation channel. In aspects, the (fourth) compensation channel extends in the longitudinal direction and/or can be moved with the main valve spool in the first valve chamber. The (fourth) compensation channel can be passed through by fluid that is displaced when the actuator piston is moved to its retracted position. If the stop flange simultaneously rests against the (second) main valve spool stop, fluid displacement would not be possible without the (fourth) compensation channel, or the fluid displacement could cause the stop flange to lift off the (second) main valve spool stop. The (fourth) compensation channel can be fluidically permeable when the main valve spool (second) main valve spool stop is applied. The (fourth) compensation channel can be closed by the (third) main valve spool stop when the main valve spool is applied to it. This prevents leakage so that fluid pressure can be built up as quickly as possible to adjust the actuator piston when the main valve spool is in the closed position.

The main valve spool and the pilot valve spool can be designed and/or arranged in such a way that, in one operating state, the main valve spool closes the first fluid path and the second fluid path, while the pilot valve spool opens the second fluid path and/or simultaneously locks the actuator piston in its extended position. This operating state can occur when the electromagnet is de-energized and/or in the spring-loaded open position of the pilot valve spool and/or locking mechanism. This allows the hydraulic actuator to be switched so that it remains closed even when an input signal is removed. This allows the actuator to be reliably locked in the extended position when the input signal is removed.

Also disclosed is an operating method. The hydraulic actuator operated in this way can be a hydraulic actuator as described in the disclosure. The operating method comprises at least the following steps in the specified order. The individual steps are assigned to operating states solely for reasons of easy comprehensibility, but the division into operating states and their designation is optional.

### First State:

The hydraulic actuator is in a basic state in which the first fluid path and the second fluid path are open, and the actuator piston is in its retracted position. The main valve spool is moved to its pre-closed position, in which the volume flow of the first fluid path is greater than the volume flow of the second fluid path. The following steps are now performed from this basic state of the hydraulic actuator.

### Second State:

The pilot valve spool is moved from its open position to its closed position, thereby closing the second fluid path.

### Third State:

The main valve spool is moved to its closed position by the fluid pressure at the inlet, thereby closing the first fluid path and the second fluid path.

### Fourth State:

The actuator piston is moved to its extended position by the fluid pressure present at the inlet.

### Fifth State:

The pilot valve spool is moved from its closed position to its open position, thereby opening the second fluid path.

### Sixth State:

The fluid pressure on the main valve spool is interrupted, and the main valve spool is moved from its closed position to its single open position or double open position.

### Seventh State:

Fluid flows through the hydraulic actuator from the inlet to the outlet along at least one of the two fluid paths. In this state, the fully open position of the hydraulic actuator can be achieved.

### Eighth State:

The volume flow at the inlet is interrupted or reduced and the pilot valve spool is moved from its open position to its closed position, thereby closing the second fluid path. In aspects, reducing the volume flow can be sufficient, for example, if the hydraulic actuator remains below a viscosity-dependent switching threshold of the main valve spool.

### Ninth State:

The actuator piston is moved to its retracted position, thereby moving the main valve spool to its pre-closed position. The basic state can then be restored. The first state can follow the ninth state.

The advantages already described above regarding the hydraulic actuator also apply analogously to the operating method, to which reference is hereby made. Further developments of the operating method are described below, sorted by state.

### First State:

The actuator piston can be locked in its retracted position by the locking device. The main valve spool can be axially spaced from its second main valve spool stop by resting against the actuator piston (pre-lock position). The actuator piston spring presses the actuator piston onto the main valve spool and/or the actuator piston can rest against the retraction stop. The volume flow from the inlet is divided into partial volume flows via the pilot valve spool or first fluid path and the main valve spool or second fluid path. The electromagnet is de-energized.

The electromagnet can be de-energized. The main valve spool can be in the pre-closed position. The pilot valve spool can be in the open position. The driving element can be in the driving position. The actuator piston can be in the retracted position. The first fluid path can be fully open from the inlet to the outlet. The second fluid path can be fully open from the inlet to the outlet. The volume flow at the inlet can be present.

### Second State:

The driving element, which can be coupled to the pilot valve spool, can be moved to the non-driving position. This can be done, for example, by energizing the electromagnet and/or against the force of the pilot valve spring. The actuator piston can thus move longitudinally. At the same time, the first fluid opening can be closed by the pilot valve spool valve so that the entire volume flow is directed via the main valve spool valve or through the first fluid path. Due to the resulting higher pressure difference across the main valve spool valve and the higher flow force at the control edge of the main valve spool valve, the latter can be closed against the force of the main valve spool valve spring.

The electromagnet can be energized. The main valve spool can (continue to) be in the pre-closed position. The pilot valve spool can move to the closed position, In aspects, by energizing the electromagnet. The driving element can move to the non-driving position, in aspects, by energizing the electromagnet. The actuator piston can (continue to) be in the retracted position. The first fluid path can (continue to) be fully open from the inlet to the outlet. The second fluid path can be closed by the pilot valve spool and at the pilot valve spool. The volume flow at the inlet can be present.

### Third State:

Both fluid paths are closed. The connection between the inlet and outlet is thus completely blocked. However, in aspects, fluid pressure can still be present at the inlet and in the first valve chamber. This fluid pressure can push the main valve spool into its closed position. The electromagnet can continue to be energized.

The electromagnet can (continue to) be energized. The main valve spool can move into the closed position, in aspects, due to fluid pressure at the inlet and/or in the first valve chamber. The pilot valve spool can (continue to) be in the closed position, in aspects, due to the electromagnet being energized. The driving element can (continue to) be in the non-driving position, in aspects, due to the electromagnet being energized. The actuator piston can (continue to) be in the retracted position. The first fluid path can be closed by the main valve spool and at the main valve spool. The second fluid path can be closed by the pilot valve spool and at the pilot valve spool and/or by the main valve spool and at the main valve spool. The volume flow at the inlet can be present.

### Fourth State:

Since both fluid paths are closed, the volume flow at the inlet, which is still present, builds up fluid pressure, in aspects, in the first valve chamber, which acts on the pressure surface of the actuator piston and can move the actuator piston to its extended position. The actuator piston can be moved against the force of the actuator piston spring. The electromagnet can continue to be energized.

The electromagnet can (continue to) be energized. The main valve spool can (continue to) be in the closed position, in aspects, due to fluid pressure at the inlet and/or in the first valve chamber. The pilot valve spool can (continue to) be in the closed position, in aspects, due to the electromagnet being energized. The driving element can (continue to) be in the non-driving position, in aspects, due to the electromagnet being energized. The actuator piston can be adjusted to the extended position, in aspects, due to fluid pressure at the inlet and/or in the first valve chamber. The first fluid path can (continue to) be closed by the main valve spool and at the main valve spool. The second fluid path can (continue to) be closed by the pilot valve spool and at the pilot valve spool and/or by the main valve spool and at the main valve spool. The volume flow at the inlet can be present.

### Fifth State:

The actuator piston is moved to its extended position, and the driving element can be moved to its driving position. This can be done by de-energizing the electromagnet. The force of the pilot valve spring can push the driving element into its driving position. The actuator piston is locked. The first fluid opening can be opened again by the pilot valve spool. However, the second fluid path can be partially open, because at the same time the main valve spool closes the second fluid opening in its closed position and the first fluid path can still be closed by the main valve spool. The fluid pressure that can be present in the first valve chamber at the actuator piston cannot be reduced. The fluid pressure that can be present in the first valve chamber pushes the main valve spool into its closed position. The locking of the actuator piston is thus decoupled from the hydraulic control. The fluid connection between the inlet and outlet remains closed, even though the pilot valve spool reopens the first fluid port. This circuit can be described as a flip-flop circuit.

The electromagnet can be switched to be de-energized. The main valve spool can (continue to) be in the closed position, in aspects, due to fluid pressure at the inlet and/or in the first valve chamber. The pilot valve spool can move into the open position, in aspects, by means of the pilot valve spool spring. The driving element can move into the driving position, in aspects, by means of the pilot valve spool spring. The actuator piston can (continue to) be in the extended position, in aspects, due to fluid pressure at the inlet and/or in the first valve chamber. The first fluid path can (continue to) be closed by the main valve spool and at the main valve spool. The second fluid path can be opened by and at the pilot valve spool, but can (continue to) be closed by the main valve spool and at the main valve spool, in aspects, at the second fluid opening. The volume flow at the inlet can be present.

### Sixth State:

The main valve spool is moved from its closed position by the spring force of the main valve spool spring when the volume flow at the inlet is switched off, in aspects, into its single open position. On its travel path, the main valve spool can pass the point at which it is located in the pre-closed position. Since the actuator piston is locked in its extended position, it cannot push the main valve spool into its pre-closed position. The main valve spool can pass the pre-closed position along its travel path. The main valve spool can rest against the second main valve spool stop, thereby opening up a maximum flow cross-section. In this state, the fully open position of the hydraulic actuator can be achieved.

The electromagnet can (continue to) be de-energized. The main valve spool can move into a single open position, in aspects, due to the shut-off or reduction of the fluid pressure at the inlet and/or in the first valve chamber and/or the main valve spool spring. The pilot valve spool can (continue to) be in the open position, in aspects, due to the pilot valve spool spring. The driving element can (continue to) be in the driving position, in aspects, due to the pilot valve spool spring. The actuator piston can (continue to) be in the extended position, in aspects, due to the latching. The first fluid path can be opened by the main valve spool and be fully open from the inlet to the outlet. The second fluid path can (continue to) be opened by and at the pilot valve spool, but can be closed by and at the main valve spool, in aspects, at the first fluid opening. The volume flow at the inlet can be shut off or reduced.

### Seventh State:

In the fully open position, there can be only very low hydraulic resistance between the inlet and outlet. The main valve spool cannot be moved from this open position because the fluid pressure at the inlet or, in addition, the fluid pressure acting in the first valve chamber or, in addition, the main valve spool spring press the main valve spool into its (single) open position and prevent it from being moved. In addition, the actuator piston cannot push the main valve spool out of the (single) open position because the actuator piston is locked in its extended position.

The electromagnet can (continue to) be de-energized. The main valve spool can (continue to) be in the single open position, in aspects, due to the main valve spool spring. The pilot valve spool can (continue to) be in the open position, in aspects due to the pilot valve spool spring. The driving element can (continue to) be in the driving position, in aspects, due to the pilot valve spool spring. The actuator piston can (continue to) be in the extended position, in aspects, due to the locking mechanism. The first fluid path can (continue to) be opened by the main valve spool and be fully open from the inlet to the outlet. The second fluid path can (continue to) be opened by and at the pilot valve spool, but can (continue to) be closed by and at the main valve spool, in aspects at the first fluid opening. The volume flow at the inlet can be switched on again or increased.

### Eighth State:

The volume flow at the inlet can be switched off and the actuator piston can be unlocked by adjusting the driving element to its non-driving position. This can be done by energizing the electromagnet. The fluid displaced by the actuator piston when it returns to the retracted position can flow through the fourth compensation channel and/or be pushed out by the main valve spool towards the outlet. Due to the large opening cross-section of the main valve spool in this position, in aspects, it will not be closed. Furthermore, the hydraulic resistance when retracting the actuator piston can be very low. The actuator piston can rest against the main valve spool in its retracted position on its travel path and carry it along with it on its travel path.

The electromagnet can be energized. The main valve spool can (continue to) be in a single open position, in aspects, due to the main valve spool spring. The pilot valve spool can move to the closed position, in aspects, due to the electromagnet being energized. The driving element can move to the non-driving position, in aspects, due to the electromagnet being energized. The actuator piston can be released from its locking position. The first fluid path can (continue to) be open by the main valve spool and can be fully open from the inlet to the outlet. The second fluid path can be closed by and at the pilot valve spool and can also (continue to) be closed by and at the main valve spool, in aspects, at the first fluid opening in each case. The volume flow at the inlet can be shut off or reduced.

### Ninth State:

The main valve spool can thus be moved by the actuator piston into its pre-closed position. In the pre-closed position, the flip-flop circuit can be reactivated. The flip-flop circuit is activated and deactivated by the position of the actuator piston. When the actuator piston is retracted to its retracted position, it pushes the main valve spool into its pre-closed position—the flip-flop circuit can be activated. If the actuator piston is extended to its extended position and locked there, it is prevented from pushing the main valve spool into its pre-closed position—the flip-flop circuit is deactivated/cannot be activated. The actuator piston can be locked again by the driving element. The default state is restored. The electromagnet can continue to be energized.

The electromagnet can (continue to) be energized. The main valve spool can move into its pre-closed position, in aspects, due to contact with the actuator piston or its actuator piston spring. The pilot valve spool can (continue to) be in the closed position, in aspects due to the electromagnet being energized. The driving element can (continue to) be in the non-driving position, in aspects, due to the electromagnet being energized. The actuator piston can move into a retracted position, in aspects, due to the actuator piston spring. The first fluid path can (continue to) be opened by the main valve spool and be fully opened from the inlet to the outlet. The second fluid path can (continue to) be closed by and at the pilot valve spool but can be opened by and at the main valve spool. The volume flow at the inlet can be present.

The hydraulic actuator can then enter the first state, for example as follows: The electromagnet can be switched off. The main valve spool can (continue to) be in the pre-closed position. The pilot valve spool can enter the open position, in aspects, by means of the pilot valve spool spring. The driving element can move into the driving position, in aspects by means of the pilot valve spool spring. The actuator piston can (continue to) be in the retracted position, in aspects, due to the locking mechanism. The first fluid path can (continue to) be opened by the main valve spool and be fully open from the inlet to the outlet. The second fluid path can be opened by and at the pilot valve spool and/or can be (continue to) opened by and at the main valve spool. The second fluid path can be fully open from the inlet to the outlet. The volume flow at the inlet can be shut off or reduced.

It should be noted that the components described herein are generally disclosed as separate components. Reference can be made to one-piece designs.

If components are disclosed multiple times, embodiments and advantages that are only described for one of the components shall also be considered to be disclosed as optional for the other corresponding components. Axial and axial direction run parallel to the longitudinal axis. Radial and radial direction run perpendicular to the longitudinal axis. Circumference and circumferential direction run around the longitudinal axis.

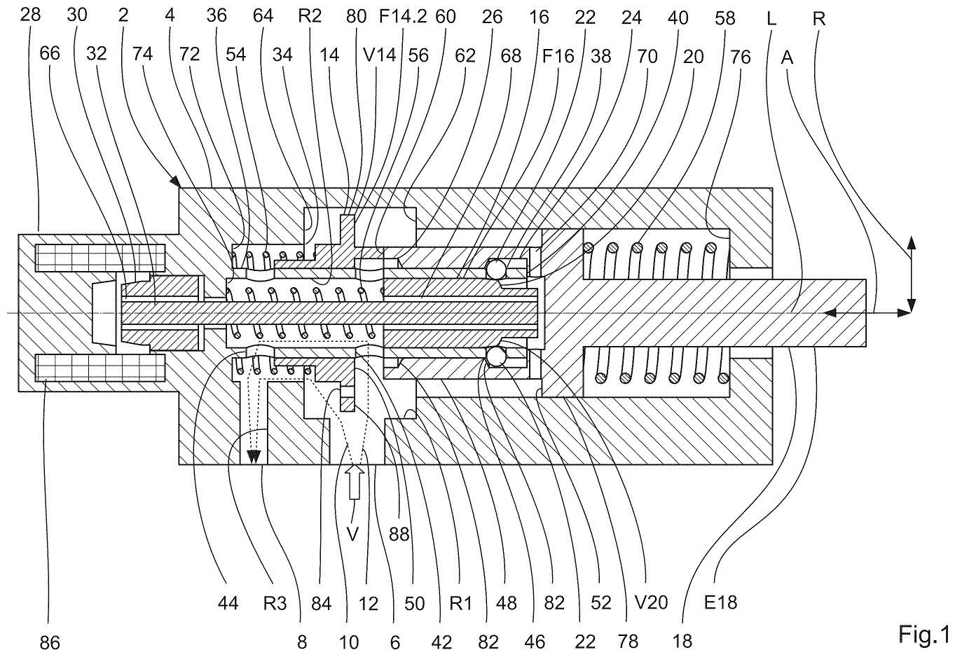

FIGS. 1 to 9 show a single hydraulic actuator 2 in nine different and chronologically successive states. For reasons of ease of comprehension, the states in the figure description correspond to the states in the general description of the disclosure.

The hydraulic actuator 2 shown is described structurally below.

The hydraulic actuator 2 is traversed by a longitudinal axis L. An axial direction A extends along the longitudinal axis L. A radial direction R runs perpendicular to this.

The hydraulic actuator 2 comprises a housing 4 with an inlet 6 and an outlet 8. A volume flow V is always present at the inlet 6.

A first fluid path 10 extends from the inlet 6 to the outlet 8 and a second fluid path 12 extends from the inlet 6 to the outlet 8.

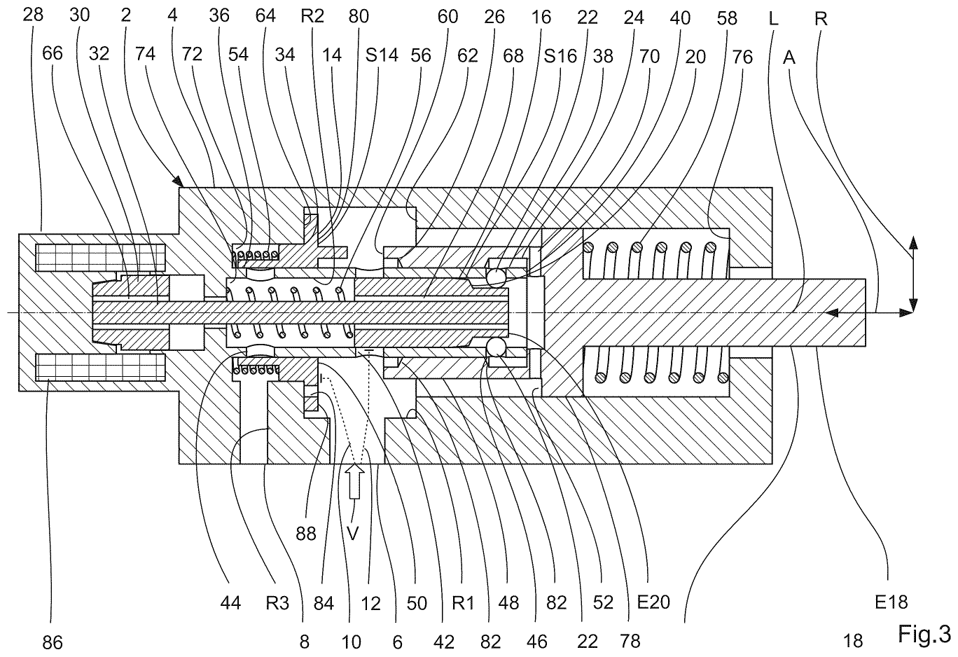

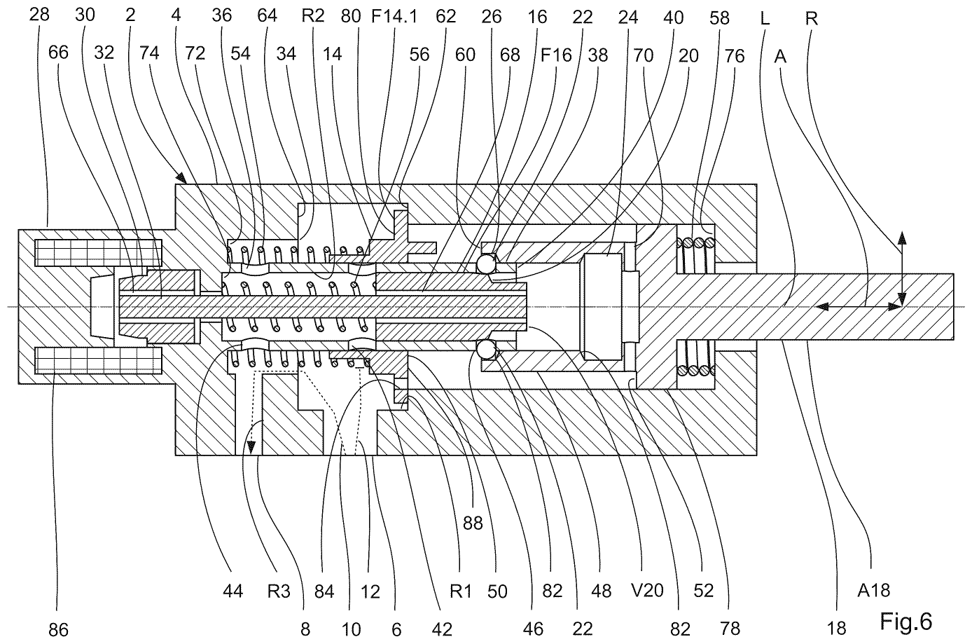

The hydraulic actuator 2 comprises a main valve spool 14 which can be adjusted along the longitudinal axis L to a single open position F14.1 (FIGS. 6-8), in which the first fluid path 10 is open and the second fluid path 12 is closed. The main valve spool 14 can also be adjusted to a double open position F14.2 (FIGS. 1, 2, 9), in which the first fluid path 10 and the second fluid path 12 are open. The main valve spool 14 can also be adjusted to a closed position S14 (FIGS. 3, 4, 5), in which the first fluid path 10 and the second fluid path 12 are closed. The main valve spool 14 comprises a closed position pressure surface 88.

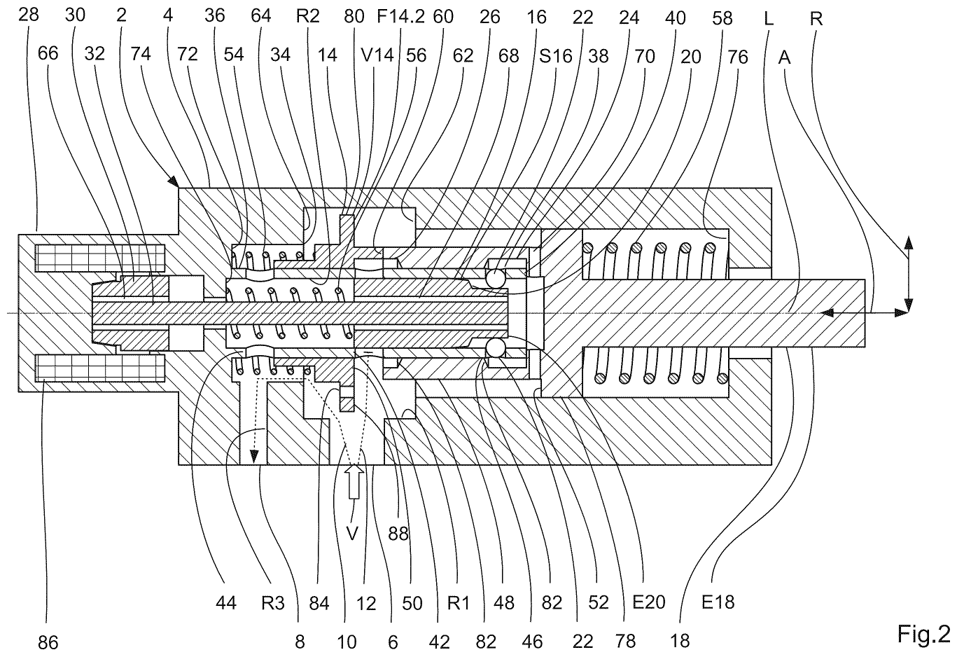

The hydraulic actuator 2 comprises a pilot valve spool 16, which is arranged coaxially with the main valve spool 14 and can be adjusted along the longitudinal axis L into an open position F16 (FIGS. 1, 5-7), in which the second fluid path (12) is open. The pilot valve spool 16 can be adjusted to a closed position S16 (FIGS. 2-4, 8, 9) in which the second fluid path 12 is closed.

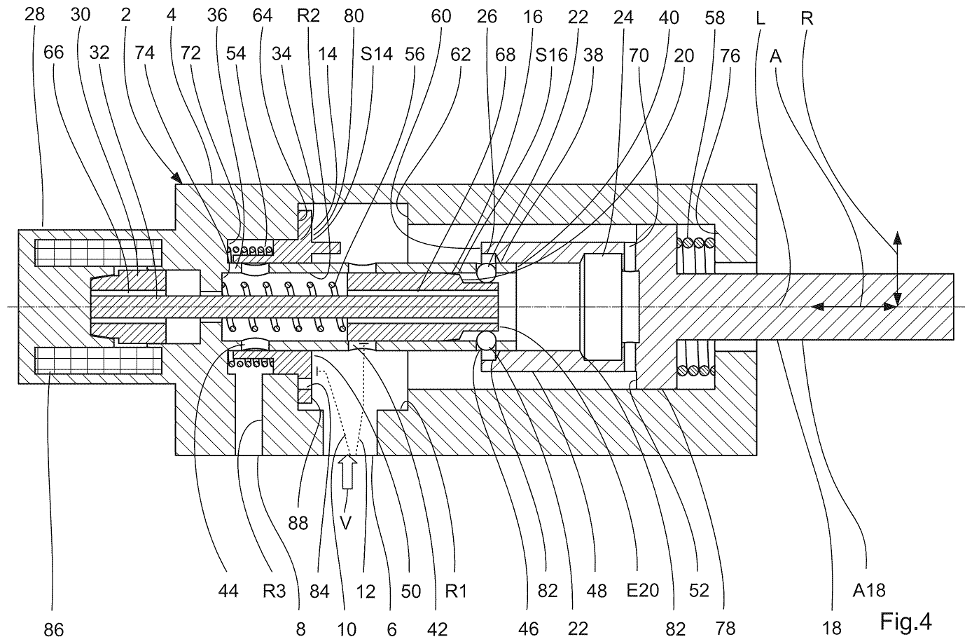

The hydraulic actuator 2 comprises an actuator piston 18, which is arranged coaxially with the main valve spool 14 and can be adjusted along the longitudinal axis L by fluid pressure from the inlet 6 between a retracted position E18 (FIGS. 1-3, 9) and an extended position A18 (FIGS. 4-8).

The hydraulic actuator 2 comprises a locking mechanism 38 comprising a driving element in the form of a cone 20 on the pilot valve spool 16, two latching receptacles 24, 26 on the actuator piston 18 and two latching elements in the form of balls 22. The balls 22 can be driven by the cone 20 into the respective latching receptacles 24, 26 (driving position V20 in FIGS. 1, 5-7) in order to latch the actuator piston 18 in the axial direction A. The cone 20 can also be moved into a non-driving position E20 (FIGS. 2-4, 8, 9), in which the balls 22 can be pushed out of the latching receptacles 24, 26 by the push-out bevels 82 of the latching receptacles.

The hydraulic actuator 2 comprises an electromagnet 28 in the form of a linear magnet.

The electromagnet has a coil 86 that can be energized selectively, an armature 30 and an armature rod 32. The electromagnet 28, the armature 30 and the armature rod 32 are arranged coaxially with the main valve spool 14. The armature 30 and the armature rod 32 are adjustable along the longitudinal axis L. A first compensation channel 66 is located between the armature 30 and the armature rod 32. A second compensation channel 68 is located between the armature rod 32 and the pilot valve spool. The electromagnet 28 forms a front end of the housing 4.

A control edge 34 is formed by the housing 4, which can adjust the volume flow of the first fluid path 10 with the main valve spool 14.

The hydraulic actuator 2 comprises an inner wall in the form of a hollow-cylindrical inner sleeve 36 inside the housing 4. The inner sleeve 36 guides the main valve spool 14 and the actuator piston 18 via its outer circumferential side. The inner sleeve 36 guides the pilot valve spool 16 via its inner circumferential side. The inner sleeve 36 has a retraction stop 40 for the actuator piston 18 at one end. At the other end, the inner sleeve 36 merges in one piece into the housing 4. The inner sleeve 36 has a first fluid opening 42, which guides the second fluid path 12 and can be selectively closed and opened by the main valve spool 14 and pilot valve spool 16. The inner sleeve 36 has a second fluid opening 44 which leads to the second fluid path 12 and can be selectively closed and opened by the main valve spool 14. The inner sleeve 36 has two latching openings 46 in which the balls 22 are received.

The housing 4 guides the main valve spool 14 partially along its travel path, namely when the main valve spool 14 has passed the control edge 34 (FIGS. 3-5). The actuator piston 18 forms a first main valve spool stop 60, against which the main valve spool 14 rests in its pre-closed position V14 (FIG. 1). The housing 4 forms a second main valve spool stop 62, against which the main valve spool 14 rests in its single open position F14.1 (FIGS. 6-8). The housing 4 forms a third main valve spool stop 64, against which the main valve spool 14 rests in its double open position (FIGS. 1, 2, 9). The housing 4 forms a support surface 72 for a main valve spool spring 54. The main valve spool spring 54 tensions the main valve spool 14 in its single open position F14.1 or against the second main valve spool stop 62. The housing 4 forms a support surface 74 for a pilot valve spool spring 56. The pilot valve spool spring 56 biases the pilot valve spool 16 in its open position F16 and also biases the cone 20 in its driving position V20. The housing 4 forms a support surface 76 for an actuator piston spring 58. The actuator piston spring 58 biases the actuator piston 18 in its retracted position E18. The inlet 6 and outlet 8 are arranged adjacent to each other along the longitudinal axis L on the housing 4. A first valve chamber R1, a second valve chamber R2 and a third valve chamber R3 are formed in the housing.

The actuator piston 18 has a sleeve portion 48 and a disc portion 78. The disc portion 78 forms a pressure surface 52 which is exposed to the first valve chamber R1. On the inner circumferential side, the sleeve portion 48 has the latching receptacles 24, 26. Furthermore, the sleeve portion 48 has a third compensation channel 70.

The main valve spool 14 has a flow-through opening 50 which leads the second fluid path 12 to the first fluid opening 42. Furthermore, the main valve spool 14 has a stop flange 80 which can rest against the second main valve spool stop 62 and the third main valve spool stop 64. In addition, the main valve spool 14 has a fourth compensation channel 84 in the stop flange 80.

The hydraulic actuator 2 shown is described functionally below.

FIG. 1 shows a first state. The hydraulic actuator 2 is in a basic state in which the first fluid path 10 and the second fluid path 12 are open and the actuator piston 18 is in its retracted position E18. The actuator piston 18 is locked in its retracted position E18 by the locking mechanism 38. The main valve spool 14 rests against the first main valve spool stop 60 and is moved to its pre-closed position V14, in which the volume flow of the first fluid path 10 is greater than the volume flow of the second fluid path 12. The main valve spool 14 rests against the actuator piston 16 and is therefore axially spaced from its second main valve spool stop 62. The actuator piston spring 58 presses the actuator piston 18 onto the main valve spool 14 and against the retraction stop 40. The hydraulic actuator 2 is in a basic state. In this state, the flip-flop circuit can be activated.

FIG. 2 shows a second state. The coil 86 is energized, thereby attracting the armature 30 and the armature rod 32. The associated pilot valve spool 16 moves accordingly from its open position F16 to its closed position S16, in which it closes the first fluid opening 42. The second fluid path 12 is closed at the location of the pilot valve spool 16. The entire volume flow V is consequently directed via the main valve spool 14 or through the first fluid path 10. Due to the resulting higher pressure difference across the main valve spool 14 and the higher flow force at the control edge 34 of the main valve spool 14, the latter can be closed against the force of the main valve spool spring 54. When the armature 30 is attracted, the driving element/cone 20 moves into the non-driving position E20.

FIG. 3 shows a third state. The pressure difference and the fluid pressure at inlet 6 cause the main valve spool 14 to move to its closed position S14 at the third main valve spool stop 64. This closes the first fluid path 10 and the second fluid path 12. The connection between inlet 6 and outlet 8 is thus completely blocked. Fluid pressure continues to be present at inlet 6 and in the first valve chamber R1.

FIG. 4 shows a fourth state. This fluid pressure, which cannot flow through the hydraulic actuator 2 due to the blockage to outlet 8, presses against the pressure surface 52 in the first valve chamber R1 and pushes the actuator piston 18 into its extended position A18. The actuator piston 18 is moved against the force of the actuator piston spring 58.

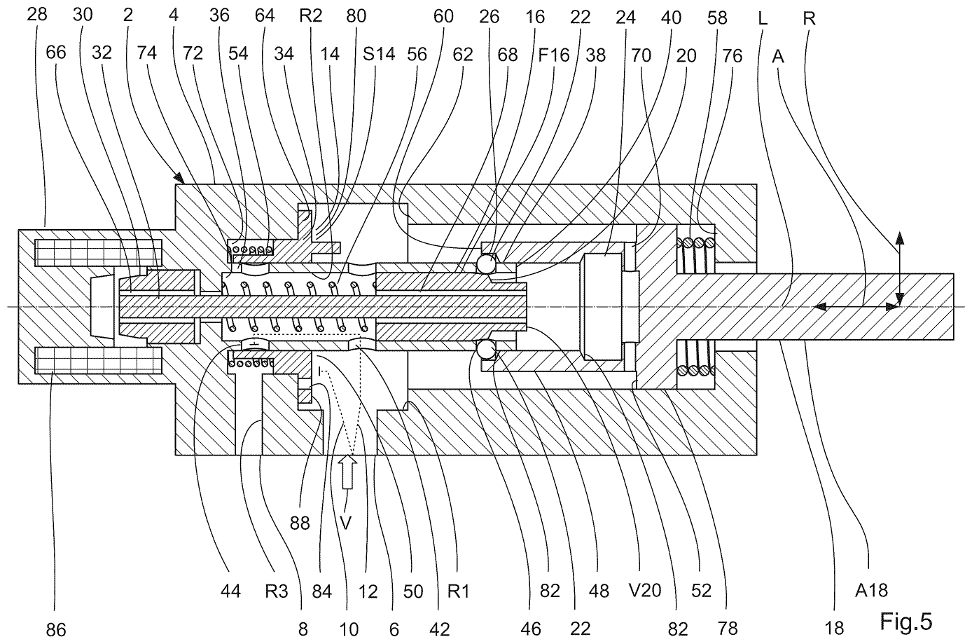

FIG. 5 shows a fifth state. The actuator piston 18 is moved to its extended position A18. The electromagnet 28 is de-energized. The pilot valve spool 16 is moved from its closed position S16 to its open position F16 by the pilot valve spring 56. The pilot valve spool 16 opens the first fluid opening 42 and reopens the second fluid path 12 there. However, the second fluid path 12 is only partially open, because the main slide valve 14 still closes the second fluid opening 44 and thus the second fluid path 12 there. The first fluid path 10 is also closed. When the actuator piston 18 is adjusted, the driving element is also moved to its driving position V20. The balls 22 are pressed into the second latching receptacles 26. The actuator piston 18 is locked in place. The fluid pressure at the actuator piston 18 cannot be reduced. The fluid pressure in the first valve chamber R1 pushes the main valve spool 14 into its closed position S14. The locking of the actuator piston 18 is decoupled from the hydraulic control. The fluid connection between inlet 6 and outlet 8 remains closed, even though the pilot valve spool 16 reopens the first fluid opening 42. This circuit can be described as a flip-flop circuit. When the actuator piston A is locked in the extended position A18, the flip-flop circuit is deactivated, in aspects after the volume flow V has been briefly interrupted or reduced.

FIG. 6 shows a sixth state. Now the fluid pressure on the main valve spool 14 can be interrupted. This can be done by switching off the volume flow V at the inlet 6. The elimination of the fluid pressure securing the closed position in the first valve chamber R1 causes the spring force of the main valve spool spring 54 to move the main valve spool 14 out of its closed position S14. In this case, the adjustment takes place in its single open position F14.1. On its travel path, the main valve spool 14 passes the point at which it was located in the pre-closed position V14. The travel path ends for the main valve spool 14 at the second main valve spool stop 62. This opens a maximum flow cross-section.

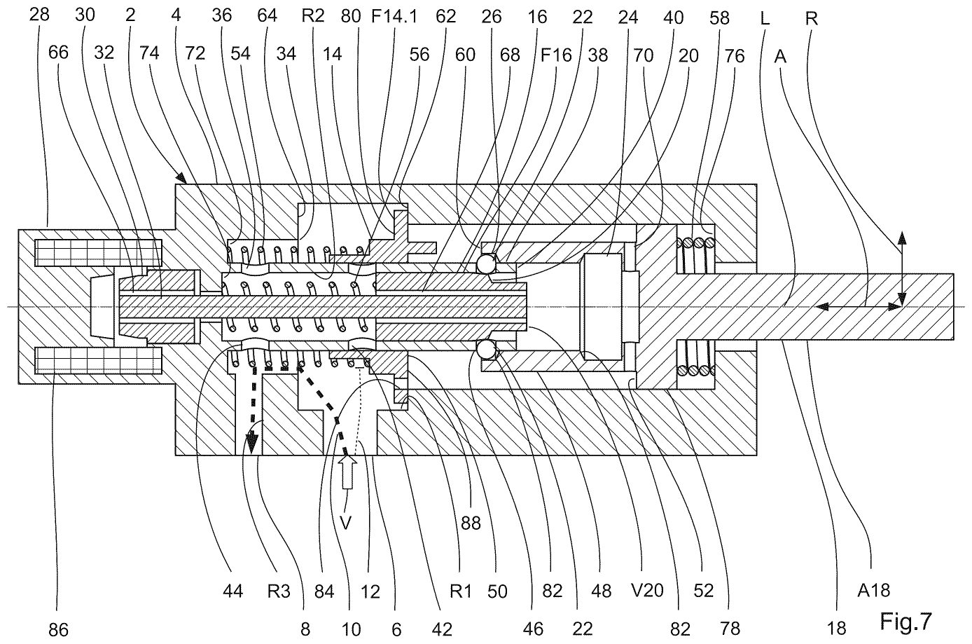

FIG. 7 shows a seventh state. The main valve spool 14 at the second main valve spool stop 62 opens the first fluid path 10. Fluid flows through the hydraulic actuator from the inlet 6 to the outlet 8 along the first fluid path 10. In this state, the fully open position of the hydraulic actuator 2 is realized. If the hydraulic actuator 2 is a parking lock, the seventh state can occur when the vehicle is in driving mode. In the fully open position, there can be very little hydraulic resistance between inlet 6 and outlet 8. The main valve spool 14 cannot be moved from this single open position F14.1 because the fluid pressure at inlet 6 and the additional fluid pressure acting in the first valve chamber R1 and the main valve spool spring 54 press the main valve spool 14 into its single open position F14.1 and prevent it from being moved out of this position. In addition, the actuator piston 18 cannot push the main valve spool 14 out of the single open position 14.1, because the actuator piston 18 is locked in its extended position A18.

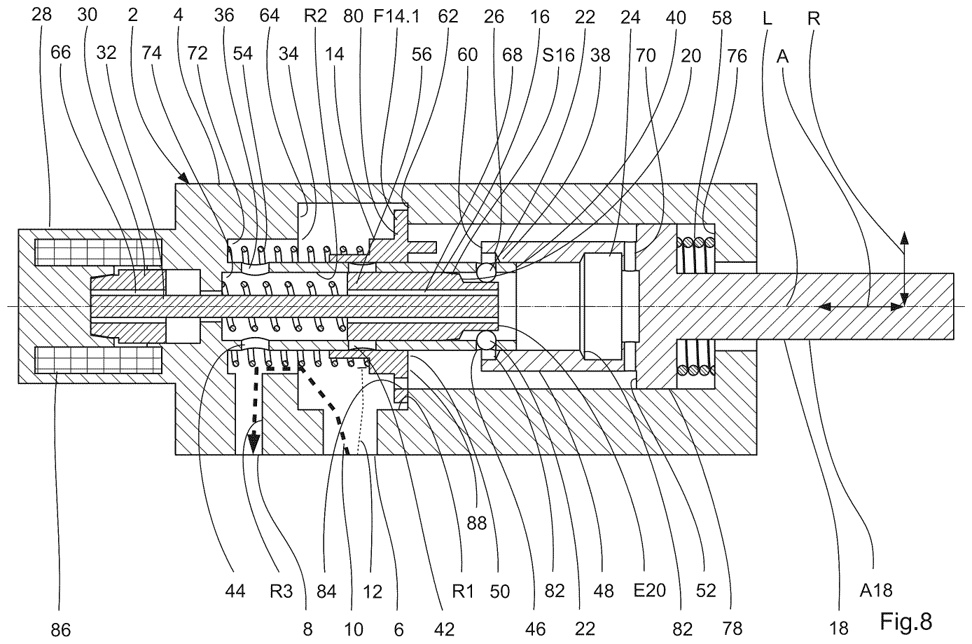

FIG. 8 shows an eighth state. The electromagnet is energized. This moves the pilot valve spool 16 to its closed position S16 and, at the same time, moves the driving element/cone 20 to its non-driving position E20. The actuator piston 18 is unlocked and can be adjusted lengthwise. The fluid pressure on the main valve spool 14 is interrupted. This can be done by switching off the volume flow V at the inlet 6. The loss of the fluid pressure securing the open position in the first valve chamber R1 causes the pressure against the pressure surface 52 of the actuator piston 18 to decrease and the actuator piston spring 58 to push the unlocked actuator piston 18 into its retracted position E18. The fluid displaced by the actuator piston 18 when it is returned to the retracted position E18 can flow through the fourth compensation channel 84 on the one hand and through the third compensation channel 70, the second compensation channel 68 and the second fluid opening 44 on the other. The fluid is also pushed out by the main valve spool 14 in the direction of the outlet 8. On its travel path, the actuator piston 18 comes into contact with the main valve spool 14 in its retracted position E18 and carries it along on the travel path against the force of the main valve spool spring 54. This lifts the main valve spool 14 off its contact with the second main valve spool stop 62.

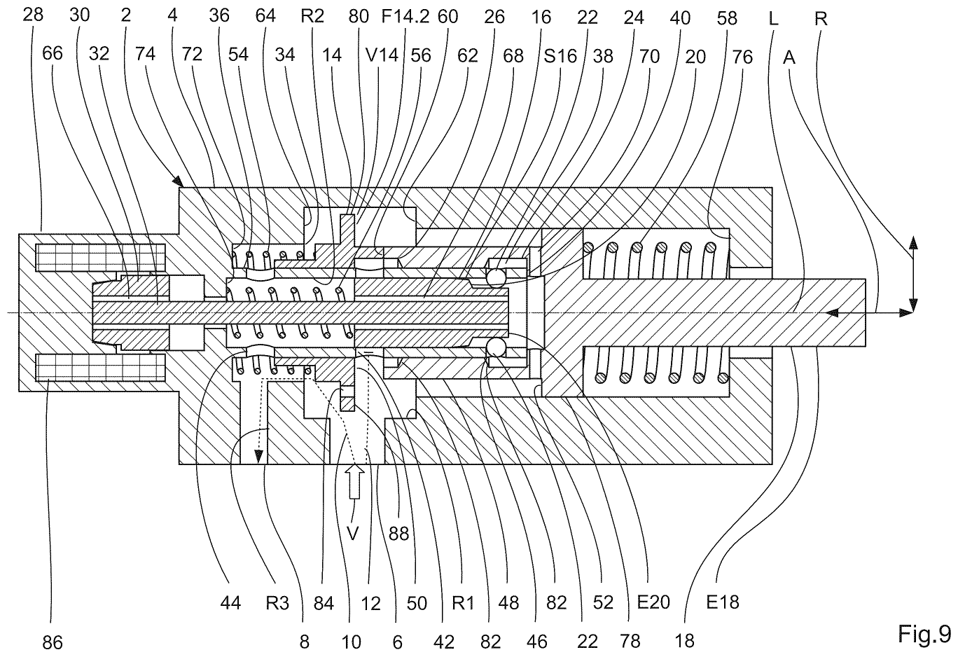

FIG. 9 shows a ninth state. The actuator piston 18 is moved to its retracted position E18, thereby moving the main valve spool 14 to its pre-closed position V14. In the pre-closed position V14, the flip-flop circuit can be reactivated.

The energization of the electromagnet 28 can be terminated. The pilot valve spool 16 is moved from its closed position S16 to its open position F16 by the pilot valve spring 56. The pilot valve spool 16 opens the first fluid opening 42 and opens the second fluid path 12 again. The second fluid path 12 is now completely free, because the main slide valve 14 is held in the pre-closed position V14—the second fluid opening 44 is open. When the actuator piston 18 is adjusted, the driving element is also moved to its driving position V20. The balls 22 are pressed into the first latching receptacles 24. The actuator piston 18 is locked in place. The basic state is restored.

The disclosure is not limited to any of the embodiments described above, but can be modified in many ways. All features and advantages apparent from the claims, the description and the drawings, including structural details, spatial arrangements and process steps, may be essential to the disclosure, both individually and in various combinations. The disclosure covers all combinations of at least two of the features disclosed in the description, the claims and/or the figures. To avoid repetition, features disclosed in relation to the device shall also be deemed to be disclosed in relation to the process and shall be claimable. Similarly, features disclosed in relation to the process shall be deemed to be disclosed in relation to the device and shall be claimable.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

List of reference signs

| | |
|---|---|
| 2 | hydraulic actuator |
| 4 | housing |
| 6 | inlet |
| 8 | outlet |
| 10 | first fluid path |
| 12 | second fluid path |
| 14 | main valve spool |
| 16 | pilot valve spool |
| 18 | actuator piston |
| 20 | cone |
| 22 | ball |
| 24 | first latching receptacle |
| 26 | second latching receptacle |
| 28 | electromagnet |
| 30 | armature |
| 32 | armature rod |
| 34 | control edge |
| 36 | inner sleeve |
| 38 | locking mechanism |
| 40 | retraction stop |
| 42 | first fluid opening |
| 44 | second fluid opening |
| 46 | latching opening |
| 48 | sleeve portion |
| 50 | flow-through opening |
| 52 | pressure surface |
| 54 | main valve spool spring |
| 56 | pilot valve spool spring |
| 58 | actuator piston spring |
| 60 | first main valve spool stop |
| 62 | second main valve spool stop |
| 64 | third main valve spool stop |
| 66 | first compensation channel |
| 68 | second compensation channel |
| 70 | third compensation channel |
| 72 | support surface |
| 74 | support surface |
| 76 | support surface |
| 78 | disc portion |
| 80 | stop flange |
| 82 | push-out bevel |
| 84 | fourth compensation channel |
| 86 | coil |
| 88 | closed position pressure surface |
| A | axial direction |
| A18 | extended position |
| E18 | retracted position |
| E20 | non-driving position |
| F14.1 | single open position |
| F14.2 | double open position |
| F16 | open position |
| L | longitudinal axis |
| R | radial direction |
| R1 | first valve chamber |
| R2 | second valve chamber |
| R3 | third valve chamber |
| S14 | closed position |
| S16 | closed position |
| V | volume flow |
| V14 | pre-closed position |
| V20 | driving position |

What is claimed is:

1. A hydraulic actuator, which is traversed by a longitudinal axis, comprising:
a housing comprising an inlet and an outlet;
a first fluid path extending from the inlet to the outlet;
a second fluid path extending from the inlet to the outlet;
a main valve spool;
a pilot valve spool; and
an actuator piston;
wherein the main valve spool is adjustable along the longitudinal axis to a single open position or to a double open position;
wherein the pilot valve spool is arranged coaxially with the main valve spool and is adjustable along the longitudinal axis between an open position in which the second fluid path is open, and a closed position in which the second fluid path is closed;
wherein the actuator piston is arranged coaxially with the main valve spool and adjustable along the longitudinal axis by a fluid pressure from the inlet between a retracted position and an extended position.

2. The hydraulic actuator according to claim 1, wherein the main valve spool is adjusted to the single open position so the first fluid path is open and the second fluid path is closed.

3. The hydraulic actuator according to claim 1, wherein the main valve spool is adjusted to the single open position so the second fluid path is open and the first fluid path is closed.

4. The hydraulic actuator according to claim 1, wherein the main valve spool is adjusted so the first fluid path and the second fluid path are open in the double open position.

5. The hydraulic actuator according to claim 1, wherein the main valve spool is adjusted so the first fluid path and the second fluid path are closed.

6. The hydraulic actuator according to claim 1, wherein the actuator piston rests against the main valve spool in the retracted position and can thereby move the main valve spool into a pre-closed position that is within the single open position and/or the double open position wherein a first volume flow of the first fluid path is greater than a second volume flow of the second fluid path.

7. The hydraulic actuator according to claim 1, further comprising a locking mechanism comprising:
a driving element;
at least one latching receptacle on the actuator piston; and
at least one latching element;
wherein the at least one latching element can be driven by the driving element into the at least one latching receptacle in order to lock the actuator piston in an axial direction.

8. The hydraulic actuator according to claim 7, wherein the driving element is a tapered element.

9. The hydraulic actuator according to claim 7, wherein the driving element is a cone.

10. The hydraulic actuator according to claim 7, wherein the driving element is on the pilot valve spool.

11. The hydraulic actuator according to claim 1, further comprising an electromagnet that adjusts the pilot valve spool along the longitudinal axis.

12. The hydraulic actuator according to claim 11, wherein the pilot valve spool is fixedly connected to a magnet armature or an armature rod.

13. The hydraulic actuator according to claim 1, wherein a control edge of the main valve spool adjusts a volume flow of the first fluid path.

14. The hydraulic actuator according to claim 1, wherein the hydraulic actuator comprises an inner wall within the housing, wherein the inner wall:
guides the main valve spool; guides the pilot valve spool; guides the actuator piston; has a retraction stop for the actuator piston; has a first fluid opening which leads the second fluid path and is closed and opened by the main valve spool, the pilot valve spool, or both the main valve spool and the pilot valve spool; has a second fluid opening which leads to the second fluid path and is closed and opened by the main valve spool; has at least one locking opening in which a locking mechanism is accommodated; or any combination thereof.

15. The hydraulic actuator according to claim 1, wherein the housing: guides the main valve spool; has a main valve spool stop for the main valve spool; forms a support surface for a main valve spool spring; forms a support surface for a pilot valve spool spring; forms a support surface for an actuator piston spring; has the inlet and the outlet adjacent to each other along the longitudinal axis; has or forms a first valve chamber; has or forms a second valve chamber; has or forms a third valve chamber; forms an inner wall in one piece; and forms an inner sleeve in one piece; or any combination thereof.

16. The hydraulic actuator according to claim 1, wherein the actuator piston:
has a sleeve portion; a disc portion; at least one latching receptacle on an inner circumferential side of the actuator piston; or any combination thereof.

17. The hydraulic actuator according to claim 1, wherein the main valve spool comprises:
a flow-through opening to guide the second fluid path, a stop flange, a compensation channel, or any combination thereof.

18. A method of operation for a hydraulic actuator, comprising:
from a basic state of the hydraulic actuator in which a first fluid path and a second fluid path are open, an actuator piston is in a retracted position, and a main valve spool is moved to a pre-closed position in which a volume flow of a first fluid path is greater than the volume flow of a second fluid path:
moving a pilot valve spool from an open position to a closed position, thereby closing the second fluid path;
moving the main valve spool to a closed position by means of a fluid pressure present at an inlet, thereby closing the first fluid path and the second fluid path;
moving the actuator piston to an extended position by means of the fluid pressure present at the inlet;
moving the pilot valve spool from a closed position to an open position, thereby opening the second fluid path;
interrupting the fluid pressure on the main valve spool and moving the main valve spool from the closed position to a single open position or to a double open position;
allowing a flow of a fluid through the hydraulic actuator from the inlet to an outlet along at least one of the two fluid paths;
interrupting or reducing the volume flow at the inlet and moving the pilot valve spool from the open position to the closed position, thereby closing the second fluid path; and
moving the actuator piston to the retracted position and thereby moving the main valve spool to the pre-closed position.
